(19) United States
(12) Patent Application Publication
(10) Pub. No.: US 2008/0207163 A1
(43) Pub. Date: Aug. 28, 2008

(54) Emergency call apparatus for vehicle

(75) Inventor: Takashi Shimizu, Gamagori-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 12/070,736

(22) Filed: Feb. 21, 2008

(30) Foreign Application Priority Data
Feb. 24, 2007 (JP) 2007-043856

(51) Int. Cl. H04M 11/04

(52) U.S. Cl. 455/404.2

(57) ABSTRACT

In an in-vehicle emergency call apparatus, after a vehicle battery starts electric discharge, electric currents flowing in from the vehicle battery are integrated to calculate a consumed electric current integrated value. When the consumed electric current integrated value reaches a specified value, a position information transmission operation may be performed. In such a case, even after the consumed electric current integrated value reaches the specified value, electric power is continuously supplied from the vehicle battery to the electric power supply device. The position information transmission operation is thereby performed continuously. The position information can be thus continuously transmitted to a service center as much as possible; a service of pursuing a stolen car can be provided as much as possible.

### CROSS REFERENCE TO RELATED APPLICATION

This application is based on and incorporates herein by reference Japanese Patent Application No. 2007-43856 filed on Feb. 23, 2007.

### FIELD OF THE INVENTION

The present invention relates to an in-vehicle emergency call apparatus including a control unit for controlling electric power supply as operating power from a vehicle battery to an electric power supply device while performing an emergency call operation with the operating power being supplied according to a start trigger signal.

### BACKGROUND OF THE INVENTION

An in-vehicle emergency call apparatus reduces the drain on a vehicle battery as follows. After an accessory (ACC) signal is switched from ON to OFF, the battery starts electric discharge. Electric currents flowing in are integrated to thereby calculate a consumed electric current integrated value. When the consumed electric current integrated value reaches a specified value, the power supply is stopped from the vehicle battery to the electric power supply device (for example, refer to Patent document 1).

Patent document 1: JP-2005-255147 A (corresponding to US2005/0181837)

An in-vehicle emergency call apparatus transmits or replies position information to a service center according to a transmission start signal from the service center with the ACC signal being OFF for the purpose of pursuing a stolen car. When the vehicle is stolen, a user desires the emergency call apparatus to continue transmitting the position information to the service center as much as possible even if the capacity of the vehicle battery is drained. However, the technology in Patent document 1 stops the power supply when the consumed electric current integrated value reaches the specified value. Thus, the technology in Patent document 1 cannot reply to the user's desire mentioned above.

### SUMMARY OF THE INVENTION

The present invention is made in view of the above-mentioned situation. It is an object of the present invention to provide an in-vehicle emergency call apparatus continuing transmitting of position information as much as possible even if a consumed electric current integrated value after start of discharge reaches a specified value.

According to a first example of the present invention, an emergency call apparatus for a vehicle is provided as follows. An electric power supply device is configured to receive electric power functioning as operating power from a vehicle battery and supply each unit or device included in the apparatus with the operating power. A consumed electric current integrating device is configured to calculate a consumed electric current integrated value by integrating consumed electric currents flowing in from the vehicle battery after the vehicle battery starts electric discharge. A control unit is configured to control electric power supply from the vehicle battery to the electric power supply device while performing an emergency call operation based on occurrence of a start trigger signal in a state where the operating power is supplied to the electric power supply device from the vehicle battery. A wireless communication device configured to receive an electric power supply stop signal from an outside. Here, if an emergency call operation is performed when the consumed electric current integrated value reaches a specified value, the control unit is further configured to continue the electric power supply without stopping the electric power supply from the vehicle battery to the electric power supply device to thereby continue the emergency call operation even after the consumed electric current integrated value reaches the specified value. If the emergency call operation is continued even after the consumed electric current integrated value reaches the specified value, the control unit is further configured to stop the electric power supply from the vehicle battery to the electric power supply device when an electric power supply stop signal is received from an outside via the wireless communication device.

According to a second example of the present invention, an emergency call apparatus for a vehicle is provided as follows. An electric power supply device is configured to receive from a vehicle battery electric power functioning as operating power. An emergency call operation control unit is configured to perform an emergency call operation based on occurrence of a start trigger signal with the operating power supplied. A consumed electric current integrating device is configured to calculate a consumed electric current integrated value by integrating consumed electric currents flowing in from the vehicle battery after the vehicle battery starts electric discharge. A power control unit is configured, if the consumed electric current integrated value reaches a specified value, to cause the electric power supply device to stop supplying of the operating power. A continuation control unit is configured, if an emergency call operation is performed, to cause the electric power supply device to continue supplying of the operating power to thereby allow continuing the emergency call operation even after the consumed electric current integrated value reaches the specified value. A wireless communication device is configured to receive an electric power supply stop signal from an outside. Here, the continuation control unit is further configured to cause the electric power supply device to stop supplying of the operating power when an electric power supply stop signal is received from an outside via the wireless communication device, even if the emergency call operation is continued after the consumed electric current integrated value reaches the specified value.

According to a third example of the present invention, a method is provided for an emergency call operation for a vehicle. The method includes the following: supplying electric power obtained from a vehicle battery functioning as operating power; performing an emergency call operation based on occurrence of a start trigger signal with the operating power supplied; calculating a consumed electric current integrated value by integrating consumed electric currents flowing in from the vehicle battery after the vehicle battery starts electric discharge; stopping supplying of the operating power if the consumed electric current integrated value reaches a specified value; continuing, if an emergency call operation is performed, supplying of the operating power to thereby continue the emergency call operation even after the consumed electric current integrated value reaches the specified value; and receiving an electric power supply stop signal from an outside via a wireless communication device to thereby stopping supplying of the operating power even if the emergency call operation is continued after the consumed electric current integrated value reaches the specified value.

### BRIEF DESCRIPTION OF THE DRAWINGS

The above and other objects, features, and advantages of the present invention will become more apparent from the following detailed description made with reference to the accompanying drawings. In the drawings:

FIG. 1 shows a functional block diagram illustrating an in-vehicle emergency call apparatus according to an embodiment of the present invention; and

FIG. 2 is a flowchart explaining a process in the emergency call apparatus.

### DETAILED DESCRIPTION OF THE PREFERRED EMBODIMENTS

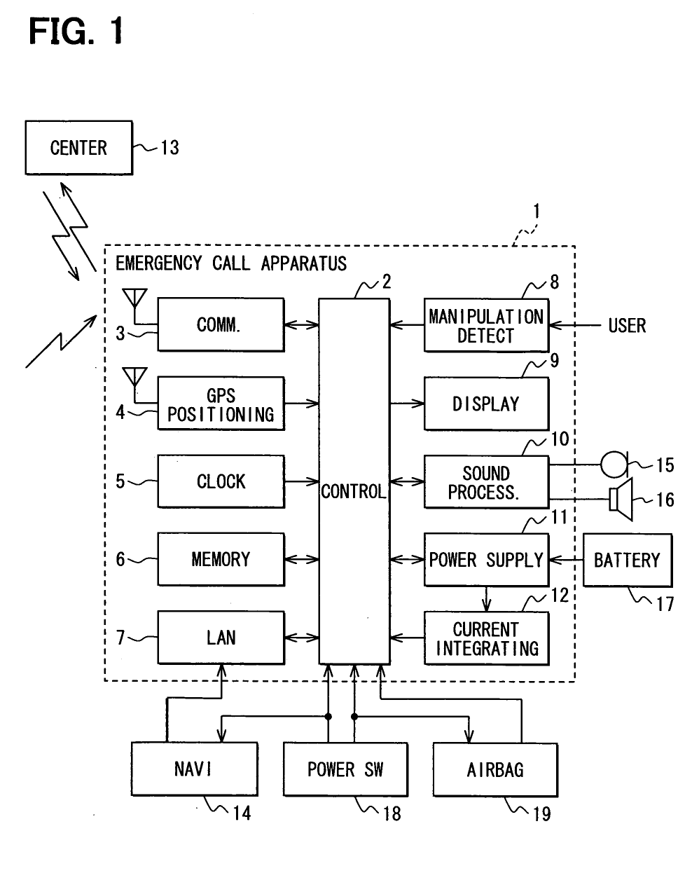

An embodiment according to the present invention will be explained with reference to drawings. FIG. 1 shows a functional block diagram of an overall configuration of an in-vehicle emergency call apparatus. The in-vehicle emergency call apparatus 1 includes: a controller 2, a wireless communication device 3, a GPS positioning device 4 functioning as a position information acquisition means or unit, a clock device 5, a memory device 6, a LAN transceiver device 7, a manipulation detection device 8, a display device 9, a sound processor 10, an electric power supply device 11, and a consumed electric current integrating device 12.

The controller 2 includes a CPU and controls overall operations of the in-vehicle emergency call apparatus 1. The wireless communication device 3 connects a communication link with a service center 13 if a position information transmission command signal is inputted from the controller 2. The position information is transmitted to the service center 13 through a wireless communication network. In such a case, while transmitting the position information to the service center 13, the wireless communication device 3 transmits to the service center 13 apparatus identification information which identifies the in-vehicle emergency call apparatus 1.

When receiving GPS signals transmitted from GPS Satellites, the GPS positioning device 4 extracts a parameter therefrom and calculates to thereby acquire position information. The clock device 5 counts time when receiving a clocking command signal from the controller 2. The memory device 6 stores various kinds of memory records. The LAN transceiver device 7 receives and acquires position information from a navigation system 14. The navigation system 14 uses a G sensor, a speed of a vehicle, etc. other than GPS signals to detect position information. Thus position information obtained from the navigation system 14 has a higher-precision than that obtained from the GPS positioning device 4.

The manipulation detection device 8 outputs a manipulation detection signal to the controller 2 when it is determined that a user performs a specified manipulation. The display device 9 displays information based on a display command signal inputted from the controller 2. The sound processor 10 performs sound processing for transmit sounds inputted via a microphone 15 or receive sounds outputted via a speaker 16.

The electric power supply device 11 is supplied with electric power from a vehicle battery 17, and supplies it to each functional block as operating power. The power switch 18 includes an ignition (IG) switch and an accessory (ACC) switch. The power switch 18 outputs an IG signal indicating ON or OFF of the IG switch to the controller 2 and an airbag system 19 while outputting an ACC signal indicating ON or OFF of the ACC switch to the controller 2 and the navigation system 14. In such a case, the controller 2 is interlocked with ON or OFF of the ACC signal from the power switch 18 to thereby switch therebetween a normal operation and a stand-by operation, respectively. Performing a stand-by operation interlocked with OFF of the ACC signal needs less power than performing a normal operation interlocked with the ON of the ACC signal. Moreover, in a stand-by operation, the controller 2 activates the wireless communication device 3 and stands by or waits for reception of a signal from an outside.

The consumed electric current integrating device 12 integrates consumed electric currents flowing in the emergency call apparatus 1 from the battery 17 immediately after the ACC signal switches from ON to OFF (i.e., immediately after the battery 17 starts electric discharge). Thus, a consumed electric current integrated value is calculated. The navigation system 14 is interlocked with ON or OFF of the ACC signal from the power switch 18, and starts or stops, respectively. The airbag system 19 outputs an air bag expansion signal to the controller 2 on condition that an input of the IG signal from the power switch 18 is ON when the air bag is developed.

In the present embodiment, the controller 2 starts a position information transmission operation with a start trigger signal for the purpose of a stolen car pursuit. The start trigger signal occurs when the wireless communication device 3 receives a position information transmission start signal from the service center 13. The position information transmission operation transmits or replies to the service center 13 position information acquired from the GPS positioning device 4 or from the navigation system 14 via the LAN transceiver device 7. The controller 2 terminates the position information transmission operation with an end trigger signal, which occurs when the wireless communication device 3 receives a position information transmission end signal from the service center 13. Moreover, the controller 2 controls the electric power supply from the vehicle battery 17 to the electric power supply device 11.

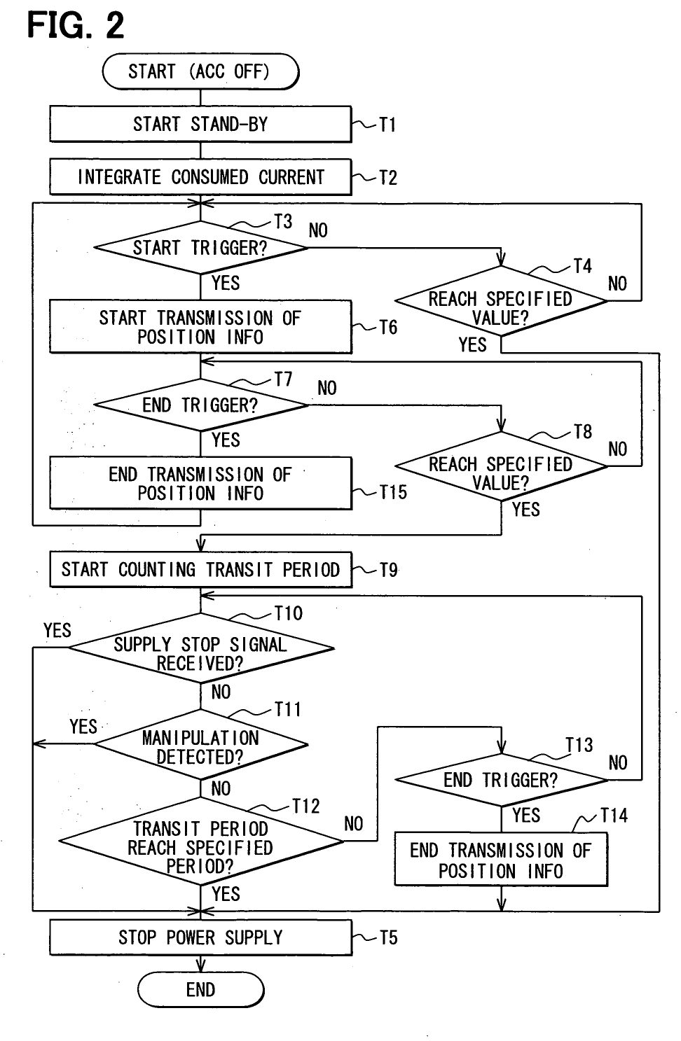

A process under the above configuration is explained with reference to FIG. 2. In the in-vehicle emergency call apparatus 1, the process starts when the controller 2 determines that an input of the ACC signal from the power switch 18 is switched from ON to OFF (i.e., the vehicle battery 17 starts electric discharge). At first, the controller 2 switches from a normal operation to a stand-by operation (task T1). The consumed electric current integrating device 12 is caused to start integrating consumed electric currents flowing in the emergency call apparatus 1 from the vehicle battery 17 (task T2). The controller 2 determines whether a start trigger signal for position information transmission operation occurs (task T3). The controller 2 determines whether the consumed electric current integrated value reaches a specified value (task T4).

The specified value herein, for example, can be designated to secure the capacity to execute a prescribed operation required after the emergency call apparatus 1 ends a position information transmission operation. For example, the specified value may be designated by an operator before shipment from a factory or at a product delivery. Alternatively, the specified value may be designated by a user after a product purchase. That is, the specified value may be designated highly in requesting that an operator or user wants to receive a stolen car pursuit service as much as possible. In contrast, the specified value may be designated low in requesting that an operator or user wants to reduce consumed electric currents of the vehicle battery 17.

When it is determined that the consumed electric current integrated value reaches the specified value, corresponding to “YES” at T4 before a start trigger of the position information transmission operation occurs, processing proceeds to task T5. That is, if the position information transmission operation is not executed when the consumed electric current integrated value reaches the specified value, electric power supply from the vehicle battery 17 to the electric power supply device 11 is stopped (task T5).

In contrast, if the controller 2 determines that a position information transmission start signal is received via the wireless communication device 3 from the service center 13 and a start trigger signal of the position information transmission operation occurs before the consumed electric current integrated value reaches the specified value (corresponding to “YES” at task T3), the position information transmission operation is started (task T6). Thereafter, the position information from the GPS positioning device 4 or navigation system 14 is transmitted to the service center 13 via the wireless communication device 3. The controller 2 determines whether a end trigger signal for position information transmission operation occurs (task T7). The controller 2 determines whether the consumed electric current integrated value reaches the specified value (task T8).

When it is determined that the consumed electric current integrated value reaches the specified value, corresponding to “YES” at T8 before a start trigger of the position information transmission operation occurs, processing proceeds to task T9. That is, the electric power supply from the vehicle battery 17 to the electric power supply device 11 is not stopped while executing the position information transmission operation, even if the consumed electric current integrated value reaches the specified value. The electric power supply is thus continued to thereby allow the position information transmission operation to be executed continuously.

Subsequently, the controller 2 causes the clock device 5 to start clocking to count a transit time period (task T9). It is determined whether the wireless communication device 3 receives a electric power supply stop signal from an outside (task T10), it is determined whether the manipulation detection device 8 detects a user's prescribed manipulation (task T11). It is determined whether when the clock device 5 starts clocking (i.e., the transit time period starting when the consumed electric current integrated value reaches the specified value) reaches a predetermined time period (task T12). The controller 2 determines whether a end trigger signal for position information transmission operation occurs (task T13). The predetermined time period herein, for example, is a period which may be designated by an operator before shipment from a factory or at a product delivery. Alternatively, the period may be designated by a user after a product purchase.

When the controller 2 determines that the wireless communication device 3 receives an electric power supply stop signal from an outside (for example, user terminal), corresponding to “YES” at task T10), processing proceeds to task T5. At task T5, the electric power supply from the vehicle battery 17 to the electric power supply device 11 is stopped. When it is determined that the manipulation detection device 8 detects a user's prescribed manipulation, corresponding to “YES” at task T11, processing proceeds to task T5, similarly. When it is determined that the transit time period starting when the consumed electric current integrated value reaches the specified value reaches the predetermined time period (“YES” at task T12), processing proceeds to task T5, similarly.

If the controller 2 determines that a position information transmission end signal is received via the wireless communication device 3 from the service center 13 and an end trigger signal for the position information transmission operation occurs after the consumed electric current integrated value reaches the specified value (corresponding to “YES” at task T1 3), the position information transmission operation is ended (task T14). The electric power supply from the vehicle battery 17 to the electric power supply device 11 is then stopped (task T5). Further, if the controller 2 determines that a position information transmission end signal is received via the wireless communication device 3 from the service center 13 and an end trigger signal for the position information transmission operation occurs before the consumed electric current integrated value reaches the specified value (corresponding to “YES” at task T7), the position information transmission operation is then ended (task T15). Processing returns to task T3.

According to the present embodiment explained above, in the in-vehicle emergency call apparatus 1, after the vehicle battery 17 starts electric discharge, consumed electric currents flowing into the apparatus 1 from the vehicle battery 17 are integrated to thereby obtain a consumed electric current integrated value. When the value reaches the specified value, it is assumed that the position information transmission operation is executed. In such a case, even after the consumed electric current integrated value reaches the specified value, electric power is continuously supplied from the vehicle battery 17 to the electric power supply device 11. The position information transmission operation is thus executed continuously. Therefore, the position information can be continuously transmitted to the service center 13 as much as possible; service of pursuing a stolen car can be received as much as possible.

Moreover, when the consumed electric current integrated value reaches the specified value, it is assumed that the position information transmission operation is not executed. In such a case, immediately after the consumed electric current integrated value reaches the specified value, the electric power supply from the vehicle battery 17 to the electric power supply device 11 is stopped. Thus, unnecessary continuation of the electric power supply from the vehicle battery 17 to the electric power supply device 11 can be prevented from occurring. The capacity of the vehicle battery 17 can be beforehand prevented from being drained.

Even after the consumed electric current integrated value reaches the specified value, electric power is continuously supplied from the vehicle battery 17 to the electric power supply device 11 to thereby continue an emergency call operation. In such a case, the electric power supply from the vehicle battery 17 to the electric power supply device 11 can be stopped (i) if the wireless communication device 3 receives a electric power supply stop signal from an outside, (ii) if the manipulation detection device 8 detects a user's prescribed manipulation, or (iii) if the transit time period starting when the consumed electric current integrated value reaches the specified value reaches a predetermined time period. The capacity of the vehicle battery 17 can be thus securable by transmitting an electric power supply stop signal from an outside (e.g., user terminal), by a prescribed manipulation of a user, or by designating a time period to stop the electric power supply from the vehicle battery 17 to the electric power supply device 11 beforehand.

The present invention is not limited only to the above-mentioned embodiment, and can be modified or extended as follows. The in-vehicle emergency call apparatus 1 may be assembled in a vehicle as an apparatus having a single body or as a module contained in another apparatus. Without limiting to the position information transmission operation which transmits, to the service center 13, the position information (e.g., present position information) obtained from the navigation system 14 for stolen car pursuit, another emergency call operation can be substituted.

A dedicated terminal connected to the in-vehicle emergency call apparatus 1 may be provided for a user to execute a prescribed manipulation through it. An IG signal may be used instead of the ACC signal. Immediately after determining that the input of IG signal from the power switch 18 is switched from ON to OFF, the normal operation is switched to the stand-by operation.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. An emergency call apparatus for a vehicle, the apparatus comprising:
an electric power supply device configured to receive electric power functioning as operating power from a vehicle battery and supply each unit or device included in the apparatus with the operating power;
a consumed electric current integrating device configured to calculate a consumed electric current integrated value by integrating consumed electric currents flowing in from the vehicle battery after the vehicle battery starts electric discharge;
a control unit configured to control electric power supply from the vehicle battery to the electric power supply device while performing an emergency call operation based on occurrence of a start trigger signal in a state where the operating power is supplied to the electric power supply device from the vehicle battery; and
a wireless communication device configured to receive an electric power supply stop signal from an outside, wherein:
if an emergency call operation is performed when the consumed electric current integrated value reaches a specified value,
the control unit is further configured to continue the electric power supply without stopping the electric power supply from the vehicle battery to the electric power supply device to thereby continue the emergency call operation even after the consumed electric current integrated value reaches the specified value; and
if the emergency call operation is continued even after the consumed electric current integrated value reaches the specified value,
the control unit is further configured to stop the electric power supply from the vehicle battery to the electric power supply device when an electric power supply stop signal is received from an outside via the wireless communication device.

2. The emergency call apparatus according to claim 1, wherein
if the emergency call operation is not performed when the consumed electric current integrated value reaches the specified value, the control unit stops the electric power supply from the vehicle battery to the electric power supply device immediately after the consumed electric current integrated value reaches the specified value.

3. The emergency call apparatus according to claim 1, further comprising:
a manipulation detection device configured to detect a predetermined manipulation of a user, wherein
if the electric power supply is continued to thereby continue the emergency call operation even after the consumed electric current integrated value reaches the specified value,
the control unit stops the electric power supply from the vehicle battery to the electric power supply device when the manipulation detection device detects the predetermined manipulation.

4. The emergency call apparatus according to claim 1, further comprising:
a clock device configured to count a transit time period from when the consumed electric current integrated value reaches the specified value, wherein
if the electric power supply is continued to thereby continue the emergency call operation even after the consumed electric current integrated value reaches the specified value,
the control unit stops the electric power supply from the vehicle battery to the electric power supply device when the transit time period reaches a predetermined time period.

5. The emergency call apparatus according to claim 1, further comprising:
a position information acquisition unit configured to acquire present position information, wherein
the control unit performs, as the emergency call operation for pursuing a stolen car, a position information transmission operation which transmits the acquired present position information to a service center via the wireless communication device.

6. An emergency call apparatus for a vehicle, the apparatus comprising:
an electric power supply device configured to receive from a vehicle battery electric power functioning as operating power;
an emergency call operation control unit configured to perform an emergency call operation based on occurrence of a start trigger signal with the operating power supplied;
a consumed electric current integrating device configured to calculate a consumed electric current integrated value by integrating consumed electric currents flowing in from the vehicle battery after the vehicle battery starts electric discharge;
a power control unit configured, if the consumed electric current integrated value reaches a specified value, to cause the electric power supply device to stop supplying of the operating power;
a continuation control unit configured,
if an emergency call operation is performed,
to cause the electric power supply device to continue supplying of the operating power to thereby allow continuing the emergency call operation even after the consumed electric current integrated value reaches the specified value; and
a wireless communication device configured to receive an electric power supply stop signal from an outside,
wherein the continuation control unit is further configured to cause the electric power supply device to stop supplying of the operating power when an electric power supply stop signal is received from an outside via the wireless communication device, even if the emergency call operation is continued after the consumed electric current integrated value reaches the specified value.

7. A method for an emergency call operation for a vehicle, the method comprising:
supplying electric power obtained from a vehicle battery functioning as operating power;
performing an emergency call operation based on occurrence of a start trigger signal with the operating power supplied;
calculating a consumed electric current integrated value by integrating consumed electric currents flowing in from the vehicle battery after the vehicle battery starts electric discharge;
stopping supplying of the operating power if the consumed electric current integrated value reaches a specified value;
continuing, if an emergency call operation is performed, supplying of the operating power to thereby continue the emergency call operation even after the consumed electric current integrated value reaches the specified value; and
receiving an electric power supply stop signal from an outside via a wireless communication device to thereby stopping supplying of the operating power even if the emergency call operation is continued after the consumed electric current integrated value reaches the specified value.
